(19) United States
(12) Patent Application Publication
(10) Pub. No.: US 2015/0262764 A1
(43) Pub. Date: Sep. 17, 2015

(54) ELECTROMAGNETIC RELAY

(71) Applicant: OMRON Corporation, Kyoto-shi (JP)

(72) Inventors: Tetsuro Tsurusu, Osaka (JP); Masayuki Noda, Osaka (JP); Tetsuya Minobe, Shiga (JP); Shuichi Itoda, Kyoto (JP)

(73) Assignee: OMRON CORPORATION, Kyoto (JP)

(21) Appl. No.: 14/643,972

(22) Filed: Mar. 10, 2015

(30) Foreign Application Priority Data
Mar. 14, 2014 (JP) 2014-052072

(51) Int. Cl. H01H 1/06; H01H 50/60

(52) U.S. Cl. CPC H01H 1/06; H01H 50/60; H01H 2203/036; H01H 2205/002

(57) ABSTRACT

An electromagnetic relay has a base, an electromagnet unit mounted on the base, and having a coil, a movable contact plate having a movable contact mounted on a distal end thereof, and a first stationary contact terminal and a second stationary contact terminal. The movable contact plate is moved by electrically energizing and deenergizing the coil of the electromagnet unit to cause the movable contact to make and break contacts with the first stationary contact terminal and the second stationary contact terminal alternately. The first stationary contact terminal and the second stationary contact terminal are implanted vertically in the base. The first stationary contact terminal supports a stationary contact. The second stationary contact terminal supports an insulating member mounted thereon.

### BACKGROUND

1. Field of the Invention

The present invention relates to an electromagnetic relay and, more particularly, to an insulation structure of the electromagnetic relay.

2. Related Art

Conventionally, there has been disclosed in Patent Document 1 an electromagnetic relay which comprises an electromagnetic block, a base, and a cover. The magnetic block has a core, a coil, and a movable spring with an armature and a movable contact mechanically engaged with the armature. The base supports a pair of stationary contacts with which the movable contact is brought into contact alternately. In this electromagnetic relay, the movable spring, the armature, and the yoke form a part of electric current passage. Also, a flexible heat conductive member is provided between the yoke and the cover to make a heat communication therebetween.

According to the electromagnetic relay, as shown in FIG. 1 in the Patent Document 1, the movable contact plate is moved by the magnetization and demagnetization of the electromagnetic block mounted on the base, causing the movable contact to contact with the normally closed stationary contact and the normally opened stationary contact 8b alternately.

Patent Document 1: JP 2006-331782 A

### SUMMARY

In a conventional electromagnetic relay, metal power particles generated by the alternate contact between the movable contact and the normally closed and opened contacts may drop and accumulate on the base. The accumulated particles may deteriorate the insulating property between the external and internal connection terminals and, eventually, may cause a short circuit therebetween.

One or more embodiments of the invention provides an electromagnetic relay with a long term, enhanced insulating property.

One or more embodiments of the invention provides an electromagnetic relay for moving a movable contact plate by electrically energizing and deenergizing a coil of an electromagnet unit mounted on a base, causing a movable contact mounted on a distal end of the movable contact plate to make and break contacts with a pair of stationary contact terminals alternately, the stationary contact terminals being implanted vertically in the base, wherein one of the stationary contact terminals supports a stationary contact and the other of the stationary contact terminals supports an insulating member mounted thereon.

Accordingly, no scattering, metal particles drop or accumulate on the proximal portion of the stationary contact terminal because it is covered by the insulating member, which prevents the opposing stationary contacts from being short-circuited by the metal particles and ensures a long, reliable and enhanced insulating property for the electromagnetic relay.

In one or more embodiments of the invention, the insulating member has opposing front and rear surfaces, and one of the front and rear surfaces opposing the movable contact supports a metal member mounted thereon.

Accordingly, the movable contact makes contact with the metal member, the scattering, metal particles are unlikely to be generated, so that the electromagnetic relay is unlikely to deteriorate for a long time.

In one or more embodiments of the invention, a lower end of the metal member extends toward the base but does not reach the base.

Accordingly, a space is formed between the lower end of the metal member and the opposing surface of the stationary contact terminal, in which no scattering, metal particles drop or accumulate, which would otherwise cause a short-circuit between the opposing stationary contacts. Also, a long, reliable and enhanced insulating property is provided for the electromagnetic relay.

In one or more embodiments of the invention, the lower end of the metal member is covered with a portion which is extended from the insulating member.

Accordingly, the lower end of the metal member is covered by the extended portion of the insulating member, extending the insulation surface distance, which results in that a long, reliable and enhanced insulating property is provided for the electromagnetic relay.

In one or more embodiments of the invention, the insulating member has an insertion hole fitted in which an upper end of the stationary contact terminal is engaged.

Accordingly, the insulating member is assembled simply by engaging the upper end of the stationary contact terminal in the insertion hole of the insulation body.

In one or more embodiments of the invention, an engaging nail is provided on and projected from an inner surface of the insertion hole of the insulating member so as to engage in a through-hole of the stationary contact terminal.

Accordingly, the engagement of the engaging projection in the through-hole of the stationary contact terminal prevents the insulating member from dropping, so that a reliable electromagnetic relay is obtained.

In one or more embodiments of the invention, the insulating member has slits provided on opposite sides of the engaging nail and an elastic nail formed between the slits.

Accordingly, the elastic deformation of the elastic nail allows the insulating member to be mounted on the stationary contact terminal easily. This provides a high productivity for the electromagnetic relay.

In one or more embodiments of the invention, the insulating member has an elastic projection which engages in a through-hole of the stationary contact terminal.

Accordingly, the insulating member can be mounted on the stationary contact terminal through the elastic projection, which ensures an enhanced productivity of the electromagnetic relay.

In one or more embodiments of the invention, the insulating member has a fixing portion projected therefrom, the fixing portion being fixed in a through-hole of the stationary contact terminal.

Accordingly, the insulating member is securely mounted on the stationary contact terminal, which prevents the insulating member from dropping and provides a highly reliable electromagnetic relay.

In one or more embodiments of the invention, the insulating member has a portion which extends from a lower end thereof toward the base but does not reach the base, the extended portion being configured to oppose and cover a surface of the stationary contact.

Accordingly, a space is formed between the extended portion and the opposing surface of the stationary contact terminal, in which no scattering, metal particles drop or accumulate in the space, which would otherwise cause a short-circuit between the opposing stationary contacts. Also, a long, reliable and enhanced insulating property is provided for the electromagnetic relay.

### BRIEF DESCRIPTION OF THE DRAWINGS

FIGS. 1A and 1B are a side view and a front view showing an electromagnetic relay according to a first embodiment of the present invention, respectively;

FIGS. 2A and 2B are perspective views showing the electromagnetic relay illustrated in FIGS. 1A and 1B as seen at different angles;

FIGS. 3A and 3B are exploded perspective views related to the perspective views in FIGS. 2A and 2B;

FIGS. 4A and 4B are a partial sectional perspective view and a partial enlarged sectional view showing the electromagnetic relay illustrated in FIG. 3A, respectively;

FIGS. 5A, 5B and 5C are perspective views and a sectional view showing an insulating member illustrated in FIGS. 1A and 1B as seen at different angles, respectively;

FIGS. 6A and 6B are a side view and a front view showing an electromagnetic relay according to a second embodiment of the present invention, respectively;

FIGS. 7A and 7B are perspective views showing the electromagnetic relay illustrated in FIGS. 6A and 6B as seen at different angles;

FIGS. 8A and 8B are exploded perspective views related to the perspective views in FIGS. 7A and 7B;

FIGS. 9A and 9B are a partial sectional perspective view and a partial enlarged sectional view showing an electromagnetic relay according to a third embodiment of the present invention, respectively;

FIGS. 10A and 10B are a partial sectional perspective view and a partial enlarged sectional view showing an electromagnetic relay according to a fourth embodiment of the present invention, respectively;

FIGS. 11A, 11B and 11C are perspective views and a sectional view showing an insulating member according to a fifth embodiment of the present invention as seen at different angles, respectively;

FIG. 12 is a partial sectional perspective view showing an electromagnetic relay according to a sixth embodiment of the present invention;

FIG. 13 is a partial sectional perspective view showing an electromagnetic relay according to a seventh embodiment of the present invention;

FIG. 14 is a partial sectional perspective view showing an electromagnetic relay according to an eighth embodiment of the present invention;

FIG. 15 is a partial sectional perspective view showing an electromagnetic relay according to a ninth embodiment of the present invention; and

FIG. 16 is a partial sectional perspective view showing an electromagnetic relay according to a tenth embodiment of the present invention.

### DETAILED DESCRIPTION

Referring to the drawings, embodiments of the invention will be described. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

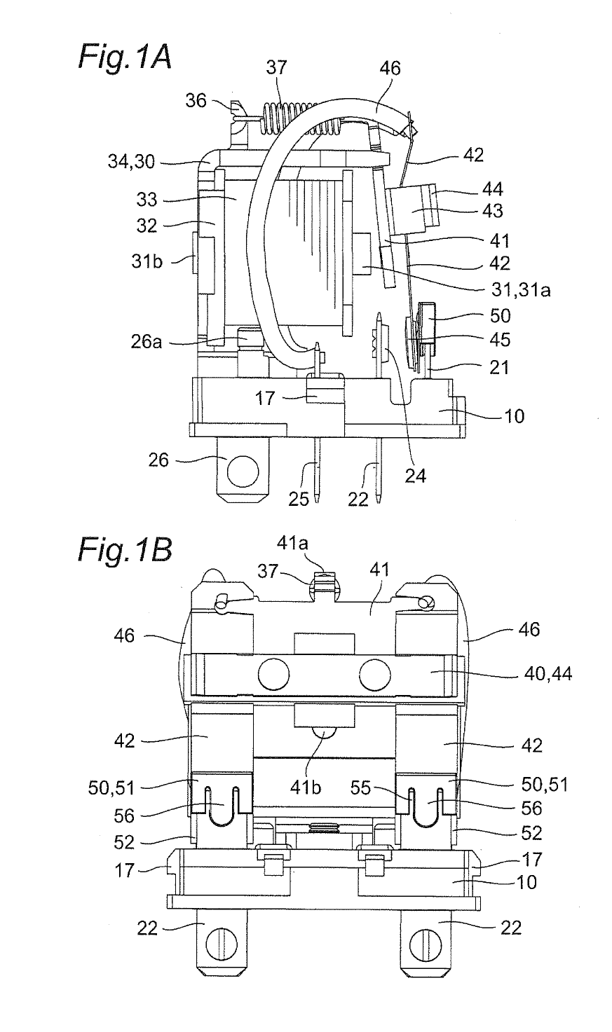

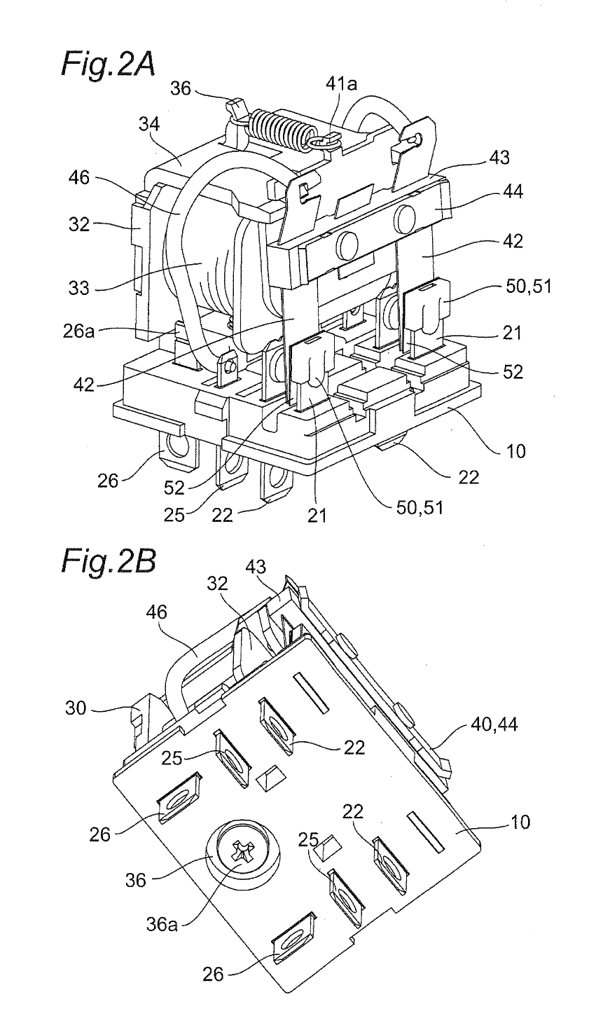

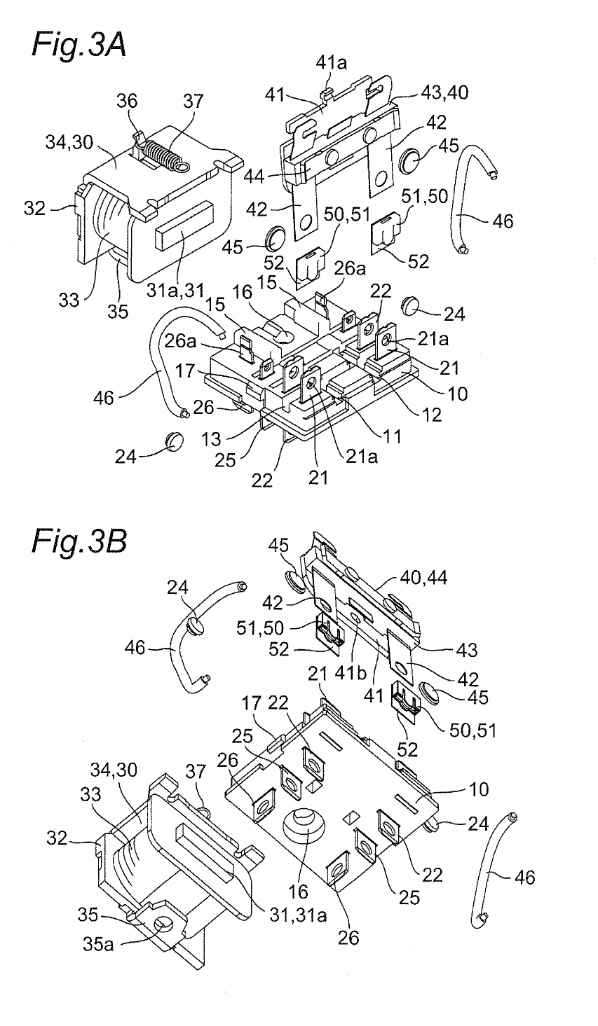

As shown in FIGS. 1A-5B, in particular FIGS. 3A and 3B, an electromagnetic relay according to a first embodiment of the invention has a base 10, an electromagnet unit 30, a movable contact unit 40, and an insulating member 50.

The base 10, which is a rectangular resin molded member, supports two sets of contact terminals vertically implanted at neighborhood corners thereof, each contact set having a normally closed stationary contact terminal 21 and a normally opened stationary contact terminal 22. Each of the normally closed stationary contact terminals 21 supports an insulating member 50 mounted thereon (which will be described below), and each of the normally opened stationary contact terminals 22 supports a normally opened stationary contact 24 fixed thereon. The upper surface of the base 10 has a transverse groove 13 formed between the normally closed stationary contact terminal 21 and the normally opened stationary contact terminal 22 and two longitudinal grooves 11 and 12 formed inward of and adjacent the normally closed and opened stationary contact terminals 21 and 22 and extending across the transverse groove 13. The base 10 also supports two coil terminals 26 vertically implanted at the remaining neighborhood corners thereof and has a pair of positioning projections 15 integrally formed therewith between and adjacent the coil terminals 26. The base 10 further has a threaded hole 16 formed therein between the positioning projections 15. A pair of movable contact terminals 25 are vertically implanted in the base 10 between the opposing normally opened stationary contact terminal 22 and the coil terminal 26. The base 10 furthermore has a pair of engaging projections 17 formed in opposing side surfaces thereof.

The electromagnet unit 30 has a spool 32, a rectangular iron core 31 inserted in the spool 32 with opposite ends thereof projected to form opposite magnetic pole portions 31a and 31b, a coil 33 wound around the spool 32, and an L-shaped yoke 34 fixed on one magnetic pole portion 31b (FIG. 1A). The lower end of the yoke 34 terminates at a mounting tongue 35 having a threaded hole 35a formed therein (FIG. 3B). The upper horizontal portion of the yoke 34 has an engaging nail 36 formed therewith for supporting one end of a return spring 37.

The electromagnet unit 30 is mounted on the base 10 with the mounting tongue 35 positioned between the positioning projections 15 and fixed on the base 10 by a screw 36a through the threaded hole 16. The opposite ends of the coil 33 are wound around the winding portions 26a of the coil terminals 26 and then soldered thereto.

The movable contact unit 40, which has an insulating block 43 and a pair of movable contact plates 42 integrally molded in the insulating block 43, is fixed by using a fixing plate 44 on a movable iron plate 41 which is pivotally connected to a horizontal, distal end of the yoke 34. The movable iron plate 41 has a magnetic shield member 41b (FIG. 3B) mounted on a portion thereof which is attracted to a magnetic pole portion 31a of the iron core 31. The movable iron plate 41 has an engaging nail 41 a extending upwardly from an upper edge thereof, with which the other end of the return spring 37 is engaged. The movable contact plates 42, which have movable contacts 45 fixed on the lower ends thereof, are connected to movable contact terminals 25 through lead wires 46 electrically connected to the upper ends of the movable contact plates 42.

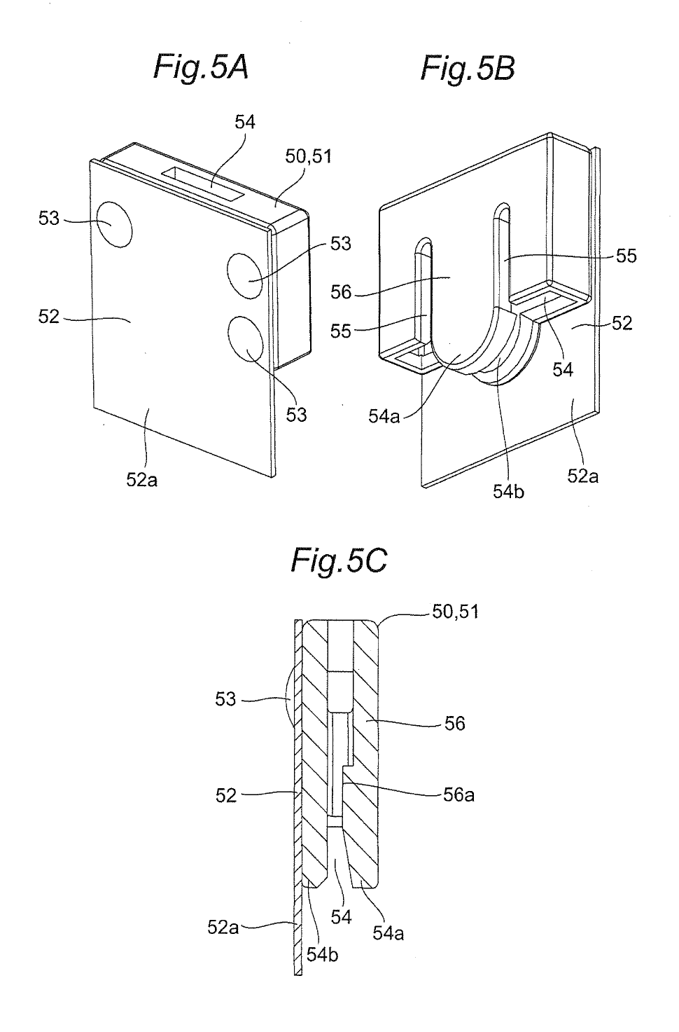

As shown in FIGS. 5A-5C, the insulating member 50 has a resin molded insulation body 51. The insulation body 51 supports a metal member 52 fixedly mounted on one surface portion opposing the movable contact 45 by three fixing portions 53. The metal member 52 has a lower end portion 52a extending from the insulation body 51. The insulation body 51 has an insertion hole 54 formed therein, which is capable of mounting from above on the upper end of the normally closed stationary contact terminal 21. The insulation body 51 further has projections 54a and 54b mounted at the center of the opening edges of the insertion hole 54. The other surface portion of the insulation body 51, away from the metal member 52, has a pair of slits 55 connected to the insertion hole 54 and an elastic nail 56 formed between the slits 55. An inward facing surface of the elastic nail 56 has a projected, engaging nail 56a for engagement with the through-hole 21 a of the normally closed stationary contact terminal 21 (FIG. 3). The projection 54a mounted on the distal end of the elastic nail 56 is positioned so that it does not surfer damage from arcing. The projection 54b adjacent the metal member 52 opposes the movable contact 45 so that an impinging impact of the movable contact 45 against the metal member 52 is absorbed and then reduced. The positions and the number of the fixing portions 53 may be determined as necessary.

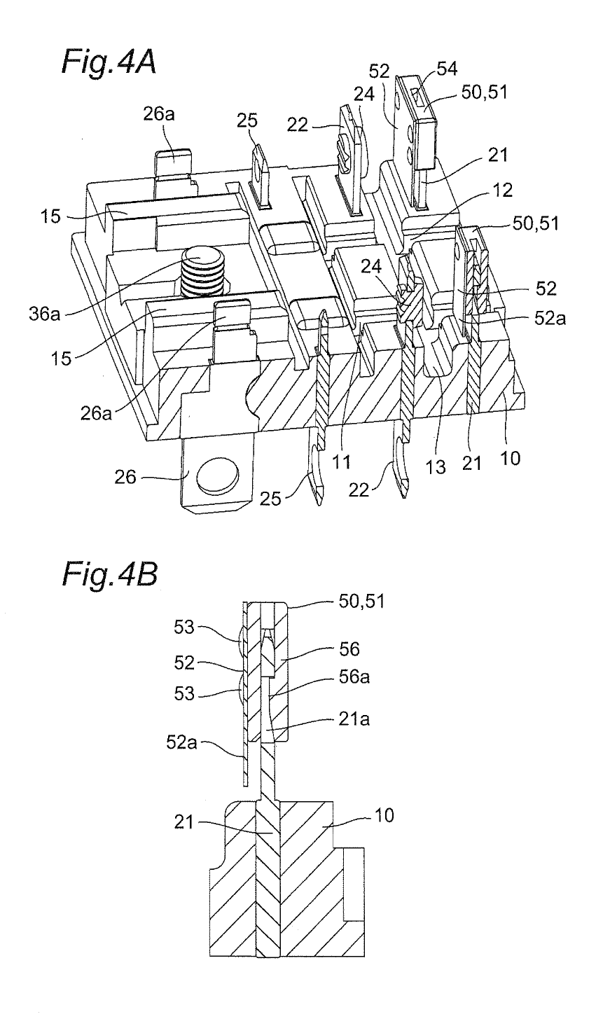

As shown in FIGS. 4A and 4B, the insulating member 50 is fitted on the upper end of the normally closed stationary contact terminal 21 from above so that the engaging nail 56a is engagingly retained the through hole 21a of the normally closed stationary contact terminal 21. In this condition, the metal member 52 opposes the movable contact 45 so that they can make and break a contact therebetween. The lower end portion 52a of the metal member 52 extends toward, but not reaches, the upper surface of the base 10.

Next, an operation of the electromagnetic relay will be described.

As shown in FIGS. 1A and 1B, when no voltage is applied to the coil 33 of the electromagnet unit 30, the movable iron plate 41 is forced by the return spring 37, which retains the movable contact 45 of the movable contact plate 42 in pressure contact with the metal member 52 of the insulating member 50.

By the application of the voltage to the coil 33 of the electromagnet unit 30, the movable iron plate 41 is attracted to the magnetic pole portion 31a of the iron core 31, which moves the movable iron plate 41 against the spring force of the return spring 37. This results in that the movable contact 45 is separated from the metal member 52 of the insulating member 50 and, instead, brought into contact with the normally opened stationary contact 24 and then the magnetic shield member 41b of the movable iron plate 41 is brought into the magnetic pole portion 31a.

When the application of the voltage to the coil 33 is halted, the movable iron plate 41 is moved by the spring force of the return spring 37 in the opposite direction, which causes that the movable contact 45 is disconnected from the normally opened stationary contact 24 and then brought into contact with the metal member 52. In this condition, an arcing which may be generated between the normally opened stationary contact 24 and the movable contact 45 does not reach the insulation body 51, which prevents the insulation body 51 from being damaged by the arcing.

The metal particles caused by the arcing may scatter and accumulate on the base, but they do not reach or accumulate on the back of the metal member 52. Namely, even if the scattering, metal particles drop and accumulate due to a number of connections and disconnections of the contacts, they are prevented from reaching the normally closed stationary contact terminal 21. Also, the normally closed stationary contact terminal 21 and the movable contact 45 are insulated from each other by the insulating member 50, no short circuit occurs between the movable contact plate 42 and the normally opened stationary contact terminal 22.

Also, an extended insulation surface distance is formed by the transverse grooves 13 and the longitudinal grooves 11 and 12 on the base 10, which increases the insulating property of the electromagnetic relay.

The transverse grooves 13 and the longitudinal grooves 11 and 12 may be replaced by slots, for example.

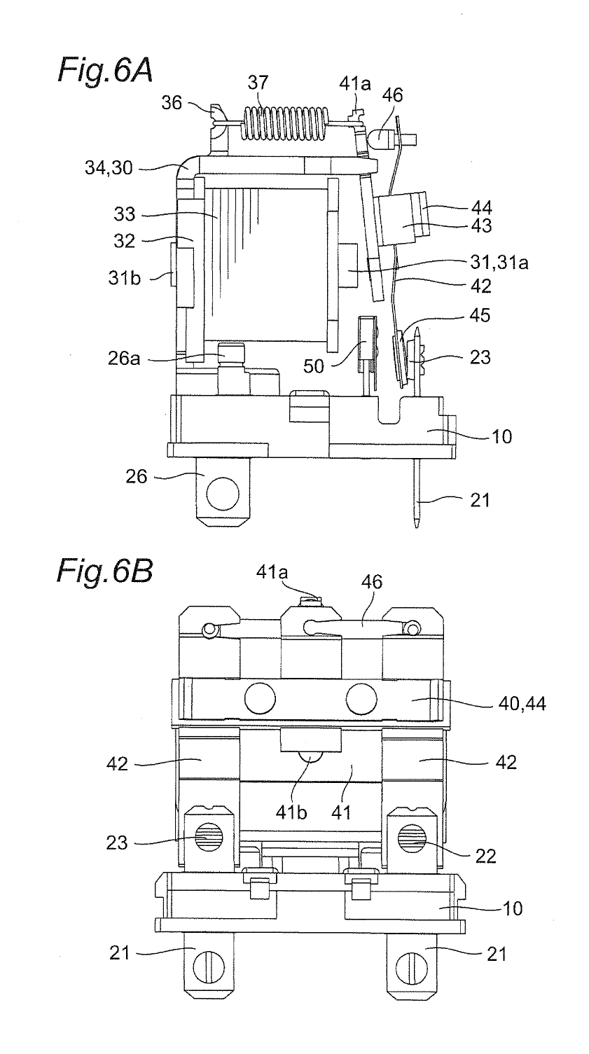

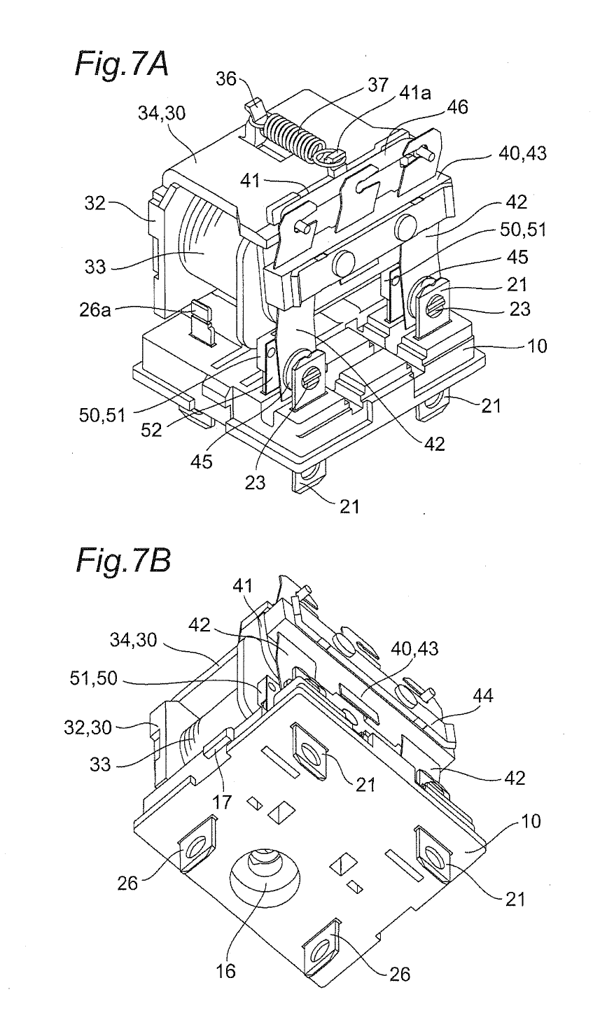

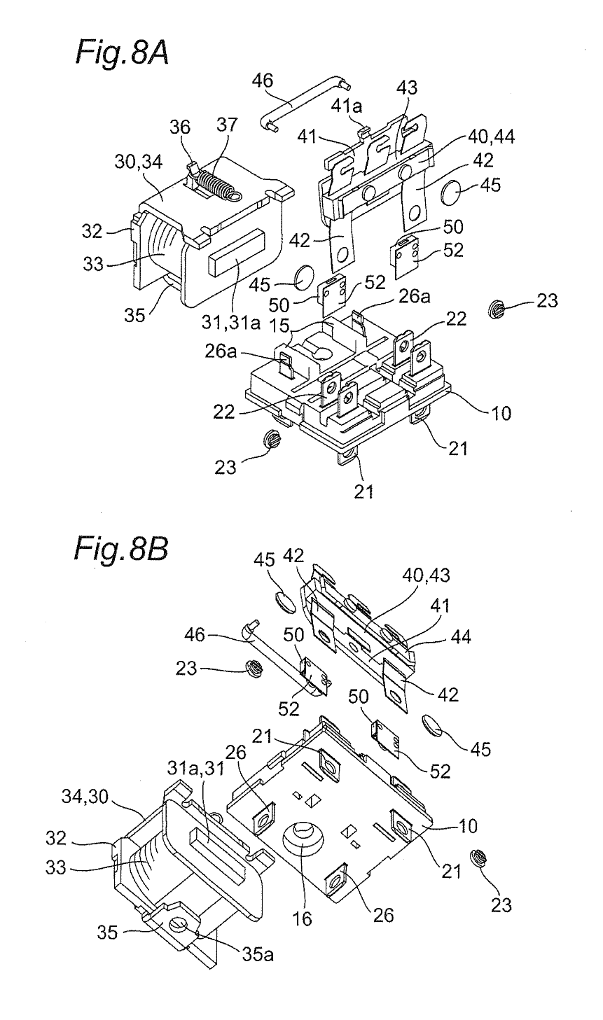

As shown in FIGS. 6A-8B, an electronic device according to a second embodiment of the invention is similar to the first embodiment except that the insulating member 50 is mounted in a different position. Specifically, the normally closed stationary contact 23 is fixed on the normally closed stationary contact terminal 21, and the movable contact 45 of the movable contact plate 42 is configured to make and break contact with the normally closed stationary contact 23. Also, the insulating member 50 is mounted on the normally opened stationary contact terminal 22. The movable contact plates 42 are electrically connected through the lead wires 46. No movable contact terminal is provided in the second embodiment. Because other structures of this embodiment are similar to those of the first embodiment, like parts are designated by like reference numerals and the duplicate descriptions are eliminated.

According to the second embodiment, an electromagnetic relay which is available in different purposes can be obtained.

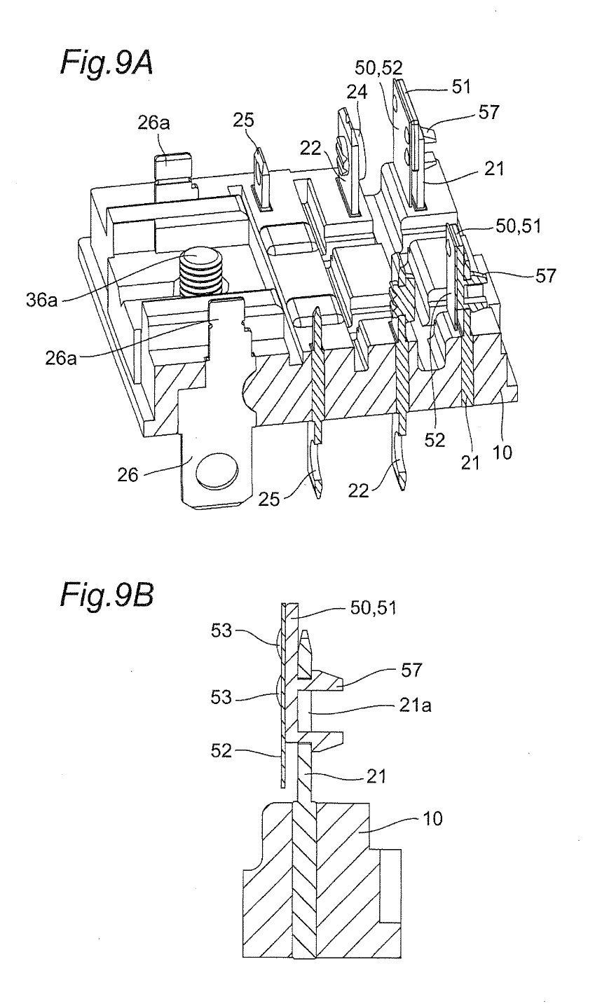

As shown in FIGS. 9A and 9B, a third embodiment of the invention has the insulating member 50 which includes the insulation body 51 and the metal member 52 fixed to the insulation body 51 at the fixing portions 53. The insulation body 51 has an elastic projection 57 which is configured to elastically engage the through-hole 21a of the normally closed stationary contact terminal 21 and to hold the normally closed stationary contact terminal 21. Of course, the insulating member 50 may be mounted on the normally opened stationary contact terminal 22. Because other structures are similar to the corresponding structures of the first embodiment, like parts are designated by like reference numerals and duplicate descriptions are eliminated.

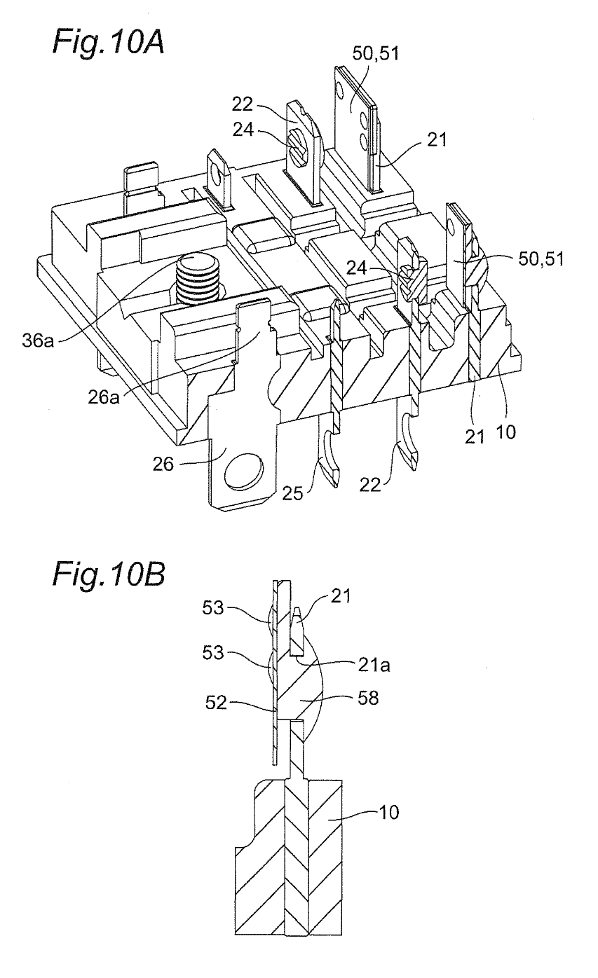

As shown in FIGS. 10A and 10B, a fourth embodiment is substantially the same as the first embodiment except that the fixing portion 58 of the insulation body 51 is fixed in the through-hole 21a of the normally closed stationary contact terminal 21. Because other structures are similar to the corresponding structures of the first embodiment, like parts are designated by like reference numerals and duplicate descriptions are eliminated.

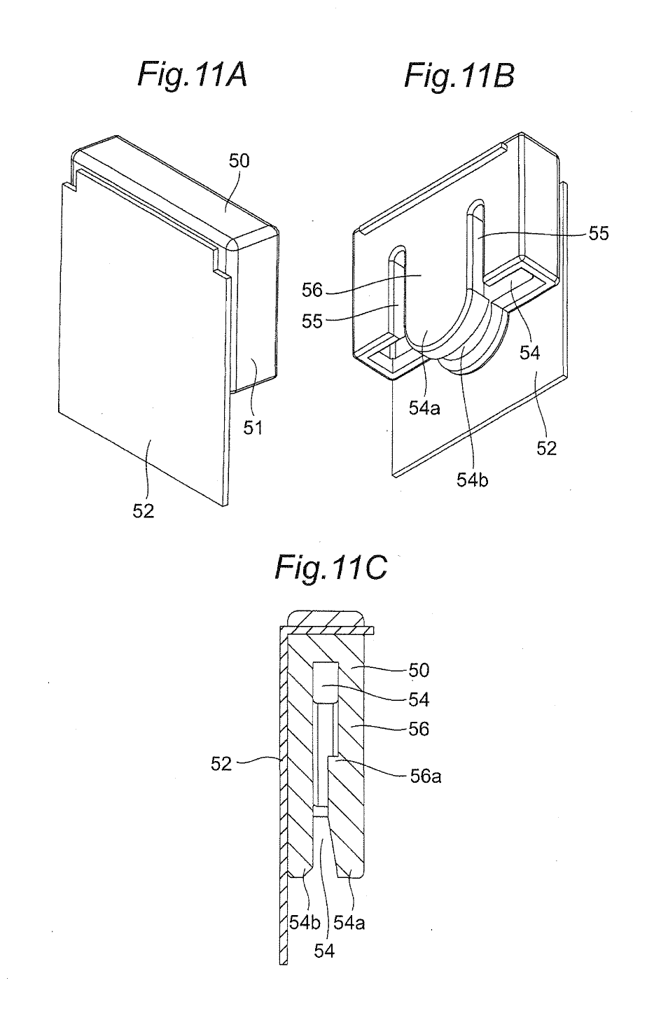

As shown in FIG. 11, the bent metal member 52 may be insert-molded in the insulation body 51 of the insulating member 50, which simplifies the assembling process to increase the productivity of the electromagnetic relay.

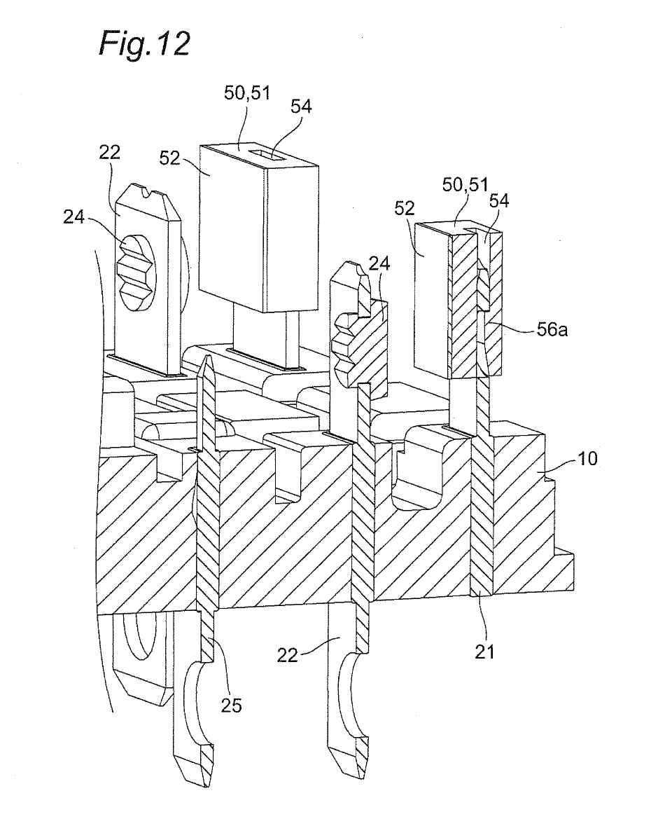

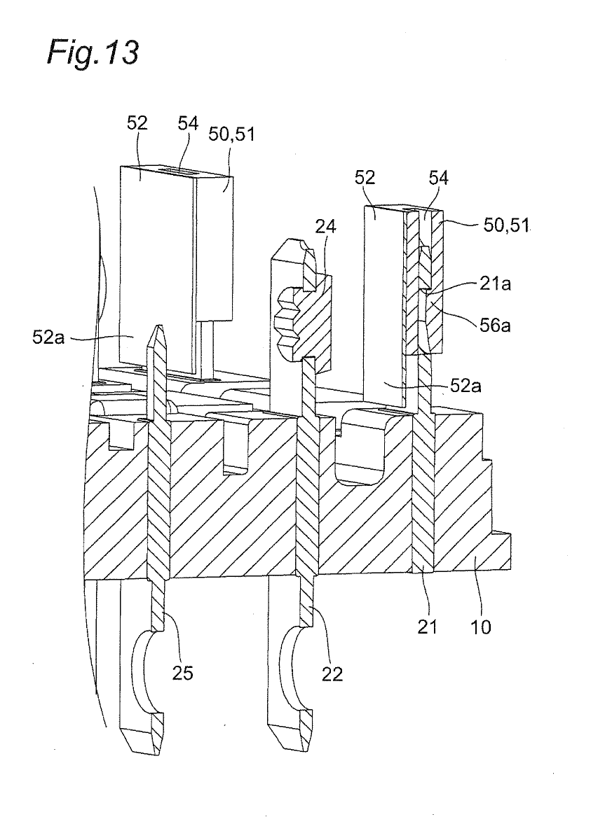

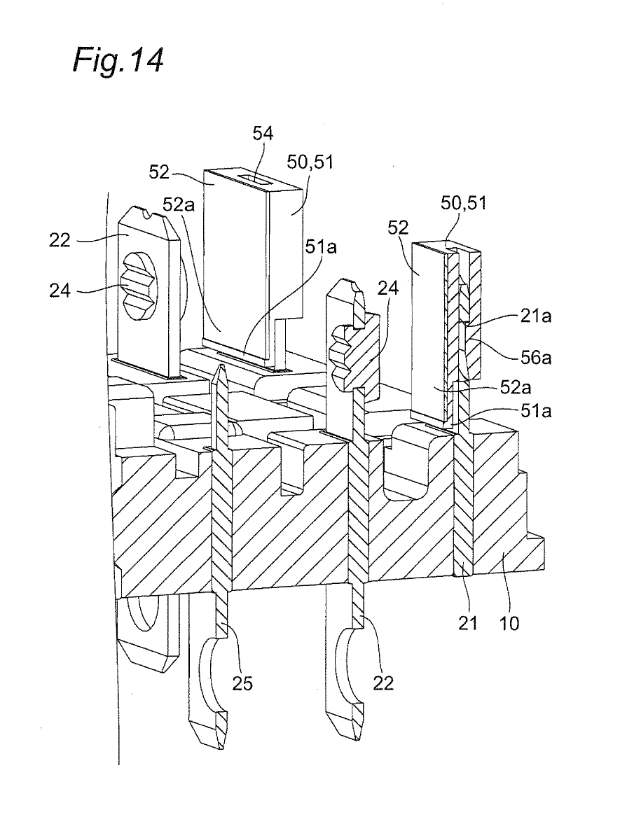

The insulating member 50 is not limited to those described in the previous embodiments and it may be modified in various ways. For example, as shown in FIG. 12 the metal member 52 may be integrally attached on one surface of the insulation body 51; namely, the outline of the metal member 52 may be the same as that of the surface of the insulation body 51 for supporting the metal member 52 (sixth embodiment). Also, as shown in FIG. 13 the insulating member 50 may be a portion which is formed by extending the lower end portion 52a of the metal member 52 (seventh embodiment). Further, as shown in FIG. 14 the lower end portion 52a of the metal member 52 may be covered by a portion 51 a which is extended from the lower end of the insulation body 51 (eighth embodiment). According to one or more embodiments of the present invention, the lower end portion 52a of the metal member 52 is covered by the extended portion 51a of the insulation body 51, which increases an insulation surface distance and, as a result, an insulation property of the electromagnetic relay.

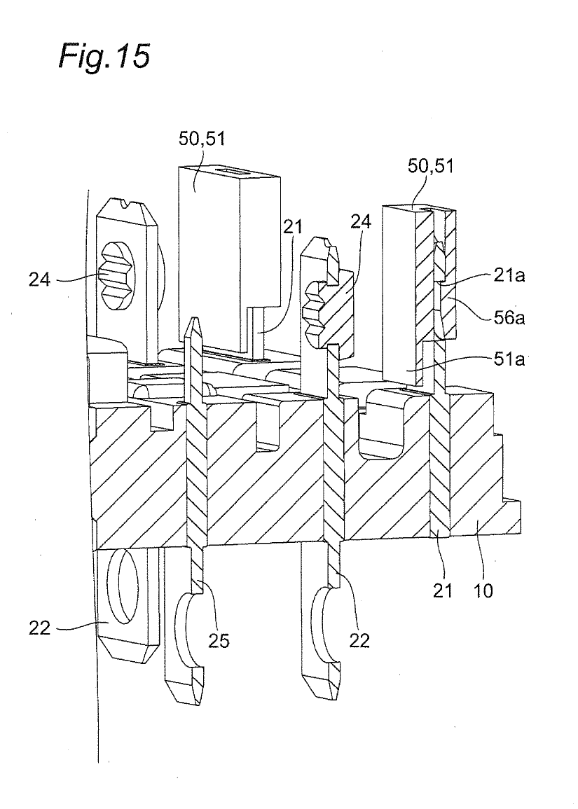

Also, in a ninth embodiment shown in FIG. 15, the metal member may be eliminated from the insulation member and, instead, the extended portion 51 a may be formed by extending the lower end of the insulation body 51.

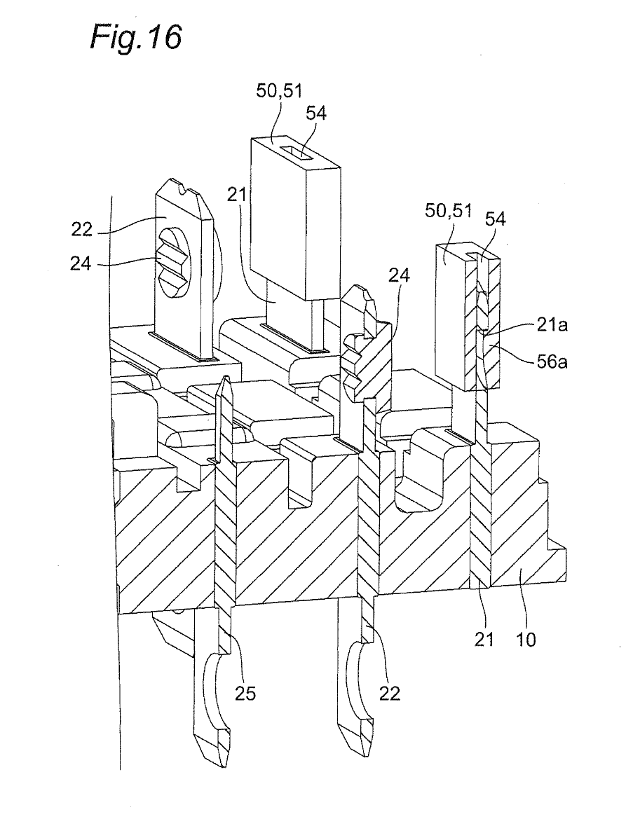

Further, in a tenth embodiment shown in FIG. 16, the lower end of the insulation body 51 may not be extended.

Furthermore, the insulation body 51 is not limited to a resin molded product and it may be a ceramic product.

Of course, the invention is not limited to the above-described electromagnetic relays and can be employed in other devices, including other electromagnetic relays.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### REFERENCE LIST

10: base
11, 12: longitudinal groove
13: transverse groove
21: normally closed stationary contact terminal
22: normally opened stationary contact terminal
23: normally closed stationary contact
24: normally opened stationary contact
25: movable contact terminal
26: coil terminal
30: electromagnet unit
31: iron core
31a: magnetic pole portion
32: spool
33: coil
34: yoke
40: movable contact unit
41: movable iron plate
42: movable contact plate
45: movable contact
50: insulating member
51: insulation body
51 a: extended portion
52. metal member
52a: lower end portion
53: fixed portion
54: insertion hole
54a: projection
54b: projection
55: slit
56: elastic nail
56a: engaging nail
57: elastic projection
58: fixed portion

What is claimed is:

1. An electromagnetic relay comprising:
a base;
an electromagnet unit mounted on the base, and comprising a coil;
a movable contact plate comprising a movable contact mounted on a distal end thereof; and
a first stationary contact terminal and a second stationary contact terminal,
wherein the movable contact plate is moved by electrically energizing and deenergizing the coil of the electromagnet unit to cause the movable contact to make and break contacts with the first stationary contact terminal and the second stationary contact terminal alternately,
wherein the first stationary contact terminal and the second stationary contact terminal are implanted vertically in the base,
wherein the first stationary contact terminal supports a stationary contact, and
wherein the second stationary contact terminal supports an insulating member mounted thereon.

2. The electromagnetic relay according to claim 1,
wherein the insulating member has opposing front and rear surfaces, and
wherein one of the front and rear surfaces opposing the movable contact supports a metal member mounted thereon.

3. The electromagnetic relay according to claim 2, wherein a lower end of the metal member extends toward the base but does not reach the base.

4. The electromagnetic relay according to claim 3, wherein the lower end of the metal member is covered with a portion which is extended from the insulating member.

5. The electromagnetic relay according to claim 1, wherein the insulating member has an insertion hole fitted in which an upper end of the second stationary contact terminal is engaged.

6. The electromagnetic relay according to claim 5, wherein an engaging nail is provided on and projected from an inner surface of the insertion hole of the insulating member so as to engage in a through-hole of the second stationary contact terminal.

7. The electromagnetic relay according to claim 6, wherein the insulating member has slits provided on opposite sides of the engaging nail and an elastic nail formed between the slits.

8. The electromagnetic relay according to claim 1, wherein the insulating member has an elastic projection which engages in a through-hole of the second stationary contact terminal.

9. The electromagnetic relay according to claim 1,
wherein the insulating member has a fixing portion projected therefrom, and
wherein the fixing portion is fixed in a through-hole of the second stationary contact terminal.

10. The electromagnetic relay according to claim 1,
wherein the insulating member has a portion which extends from a lower end thereof toward the base without reaching the base, and
wherein the extended portion is configured to oppose and cover a surface of the stationary contact.
